(19) United States
(12) Patent Application Publication
(10) Pub. No.: US 2012/0032382 A1
(43) Pub. Date: Feb. 9, 2012

(54) MOVABLE WORK PIECE CLAMPING MECHANISM

(75) Inventors: Eric Hendrickson, Palatine, IL (US); Jan Koegel, Arlington Heights, IL (US)

(73) Assignees: Robert Bosch GmbH, Stuttgart (DE); Robert Bosch Tool Corporation, Broadview, IL (US)

(21) Appl. No.: 12/852,131

(22) Filed: Aug. 6, 2010

(51) Int. Cl. B25B 1/00

(52) U.S. Cl. 269/86

(57) ABSTRACT

Embodiments of the invention comprise a clamping mechanism for securing a work piece on a power tool having a working surface and a guide fence, the clamping mechanism including a support configured to be movable along the guide fence and a clamp interconnected to the support, the clamp being movable between a securing position and a release position, wherein in the securing position, the clamp engages a work piece, and in the release position, the clamp is disengaged from the work piece.

### BACKGROUND OF THE INVENTION

The present invention generally relates to power tools and more specifically, to a clamping mechanism for securing work pieces on such tools.

Many power tools and particularly table saws typically include a frame with a table top having an upper surface and a blade extending through an opening in the upper surface. The upper surface supports a work piece, such as a piece of wood, as it is pushed towards the blade for cutting. Relatively large stand-alone table saws are able to cut larger and heavier work pieces whereas the smaller portable table saws are used mostly for smaller work pieces.

A guide fence, such as a rip fence or a miter fence, is commonly attached to table saws for aligning and guiding a work piece during cutting. Rip fences are generally removable and can be adjustably positioned relative to the blade, and usually extend from the front to the rear of the table top and are oriented in a direction parallel to the plane of the saw blade. Miter fences generally have a lower extension that fits in a slot in the table top that is parallel to the plane of the blade and have a front fence surface that can be used to push the work piece through a cutting region adjacent to the cutting blade. A miter fence generally can either be fixed to the table top where a section of the table top is movable in a direction parallel to the blade so that the miter fence can support the work piece as the work piece and the sliding table top section are pushed through the blade, or the miter fence can be movable about a section of the table top that is fixed and the user manually pushes the miter fence and the work piece through the blade.

There are universal fences that are commercially marketed that perform the function of a miter fence as well as a rip fence and are particularly useful for table saws that are known as push-pull saws that are more prevalent in European markets than in the United States. This particular type of saw has a cutting blade that is mounted to a carriage assembly that rides along guide rails, elongated rods or the like underneath the saw table top, with the blade extending upwardly through an elongated slot. The blade can be vertically adjusted as well as angularly adjusted for bevel cuts and can be operated in the same manner as conventional table saws commercialized in the United States where a work piece is moved along the table top to engage the blade and make a cut.

The push-pull saw can also be operated in a manner wherein the user can manually pull a handle or knob to move the saw blade and carriage assembly from the rear part of the slot forwardly to make cuts on a work piece that is placed at a stationary position on the table top. Universal fences used with such push-pull saws are generally mounted on table top near the front or left of the saw blade to position and guide the work piece. When the saw is pulled toward the front, the saw blade is brought into cutting position to cut through the work piece.

During cutting, a user typically places one of their hands on the work piece to hold the work piece against the fence. By placing one or both hands on the work piece in close proximity to the cutting blade, the risk of a user's hands being injured by the blade is increased. The work piece can also move away from the fence during cutting causing inaccurate cuts. In some circumstances, a separate tool, such as a push stick, is used to engage and push the work piece into the cutting blade. The tool enables a user to position their hands away from the work piece thereby lessening the risk of injury. However, such tools are not secured to the work piece or the fence. As a result, the work piece can still move out of position relative to the fence, which leads to inaccurate cuts and wasted material.

Existing methods of guiding work pieces through a cutting blade on a table saw therefore pose significant safety issues and can increase costs due to cutting inaccuracies and waste.

### SUMMARY OF THE INVENTION

Embodiments are disclosed for a clamping mechanism for securing a work piece on a power tool having a working surface and a guide fence. The clamping mechanism includes a support configured to be movable along the guide fence and a clamp interconnected to the support, the clamp being movable between a securing position and a release position, wherein in the securing position, the clamp engages a work piece, and in the release position, the clamp is disengaged from the work piece.

### DESCRIPTION OF THE DRAWINGS

FIG. 1 is a front perspective view of a power table saw including a clamping mechanism in accordance with an embodiment of the present invention.

FIG. 2 is a side perspective view of the clamping mechanism of the present invention.

FIG. 3 is an enlarged exploded view of the clamping mechanism of FIG. 2.

FIG. 4 is a cross-section view of the clamping mechanism and bracket attached to the fence shown in FIG. 1.

FIG. 5 is a perspective view of the bracket that secures the clamping mechanism to the fence.

FIG. 6 is a cross-section view of the clamping mechanism shown in FIG. 4 taken substantially along line 6-6.

FIG. 7 is a cross-section view of the securing member that secures the position of the bracket relative to the fence where the bottom end of the securing member is disengaged from the inner surface of the channel defined by the fence.

FIG. 8 is a cross-section view of the securing member of FIG. 7 where the securing member is engaged with the inner surface of the channel.

FIG. 9A is a schematic drawing of the clamping mechanism secured to the fence where the clamping mechanism is in the release position.

FIG. 9B is a schematic drawing of the clamping mechanism of FIG. 9A where the clamping mechanism is in the securing position.

FIG. 10 is a front perspective view of another embodiment of the clamping mechanism where the clamping mechanism is secured to a fence relative to a work piece.

FIG. 11 is a rear perspective view of the clamping mechanism shown in FIG. 10.

FIG. 12 is a side view of the clamping mechanism of FIG. 10 showing the clamping mechanism in the securing position and the release position.

FIG. 13 is a side perspective view of another embodiment of the ratchet assembly associated with the clamping mechanism.

FIG. 14 is a cross-section view of the clamping mechanism and the ratchet assembly shown in FIG. 13.

FIG. 15A is a schematic drawing of the clamping mechanism in the release position.

FIG. 15B a schematic drawing of the clamping mechanism and the ratchet assembly where the ratchet assembly secures the clamping mechanism at a particular position relative to a work piece.

FIG. 16 is a side perspective view of a further embodiment of the clamping mechanism where the clamping mechanism is secured to a fence relative to a work piece.

FIG. 17 is an enlarged cross section view of the connecting portion of the clamping mechanism of FIG. 16.

### DETAILED DESCRIPTION

Embodiments of the present invention are directed to a clamping mechanism for securing a work piece on a power tool such as a table saw having a working surface and a guide fence such as a rip fence, a miter fence, a universal fence or any other suitable fence used on a table saw, push-pull saw or miter saw. The clamping mechanism includes a support configured to be movable along the guide fence and a clamp interconnected to the support, the clamp being movable between a securing position and a release position, wherein in the securing position, the clamp engages a work piece, and in the release position, the clamp is disengaged from the work piece.

Certain embodiments of the present invention illustrated and described herein are particularly suited for use with a universal fence that is designed and configured to be used with push-pull type power table saws and conventional table saws. It should be appreciated that the present clamping mechanism can be used on other types of fences such as miter fences and rip fences.

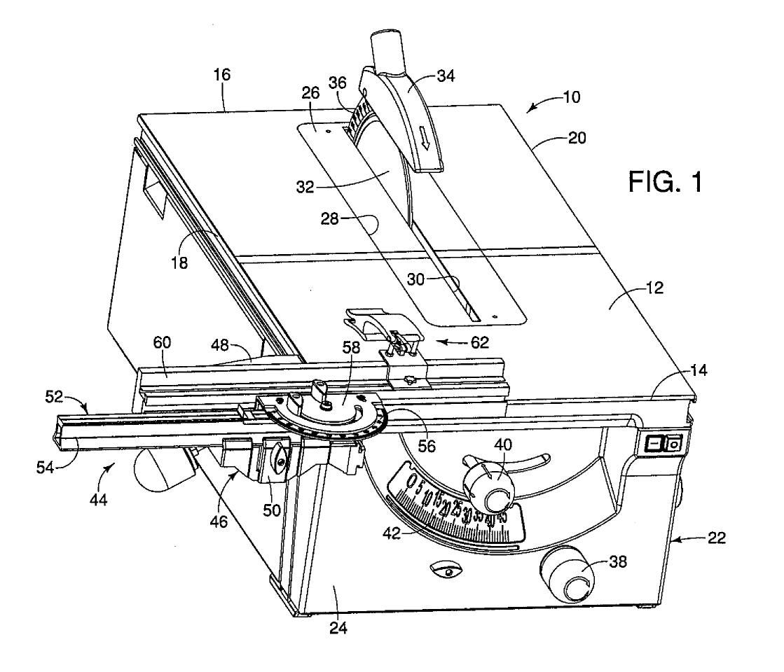

Turning now to the drawings, and particularly FIG. 1, a push-pull type table saw is indicated generally at 10 and has a table surface 12 that is generally rectangular in shape, with a front vertical surface 14, a rear vertical surface 16, a left side vertical surface 18, and a right side vertical surface 20. The saw has a base frame, indicated generally at 22, that includes a front 24, and a table top insert 26 that fits within a recess 28, with the insert 26 having a slot 30 through which a blade 32 extends. The blade has a blade guard 34 supported by a riving knife 36 that is mounted on a carriage mechanism (not shown) that supports a drive motor and gear arrangement and the blade, where the carriage mechanism is mounted for sliding movement on elongated rails, rods, extrusions or the like. The movement of the carriage mechanism is controlled by a mechanism that is connected to a front knob 40 that an operator can pull to move the blade forwardly from the position shown in FIG. 1 preferably through the full length of the slot 30.

The construction and operability of the push-pull saw is not in and of itself a part of the present invention except insofar as it has a fence in which the embodiments of the present clamping mechanism are particularly suited for use with. The saw 10 is also capable of making angled cuts on a work piece 39 and to this end, a rotatable knob 38 can be used to adjust the angle of the plane of the blade from the 90° or vertical position shown in FIG. 1 to an angled orientation that is shown in a gauge 42 that indicates it can be adjusted to about a 45° angle.

A universal fence is indicated generally at 44, and comprises a main body, indicated generally at 46, which is preferably an aluminum casting which forms a table extension 48 that extends from a holding mechanism portion 50 that is located on the opposite or forward end of the mechanism. The holding mechanism portion 50 is designed and configured to hold an elongated fence assembly, indicated generally at 52, which comprises an elongated rail member 54, a miter base 56 and a miter frame 58 mounted on the miter base. An elongated fence member 60 is slidably attached to the miter frame 58.

The universal fence 44 is adjustable so that different cuts can be made on a work piece. For example, in the position shown in FIG. 1, the universal fence 44 acts as a miter fence where a work piece is placed against the universal fence and the table saw 10 is pulled towards the work piece to cut it. The universal fence 44 can also be rotated plus or minus 90° to act as a rip fence where the work piece is aligned parallel to the fence and guided into the saw blade 32.

The present clamping mechanism 62 is attached to the fence member 60 of the universal fence. The clamping mechanism 62 includes a clamp support 64 and a pivot member 66 that is pivotably connected to the clamp support. The clamp support 64 includes a tubular portion 68 defining a through-hole 70 and two spaced apart support posts 72 having top ends 74 and bottom ends 76 where the posts are vertically oriented relative to the top surface of the fence member 60. The bottom end 76 of each post 72 includes a threaded portion that is attached to a support bracket 78 by inserting the bottom ends 76 of the posts through corresponding through-holes 79 defined by the bracket as described below. Alternatively, the posts 72 can be secured in receptacles or holes defined by the fence member 60. The top end 74 of each post 72 includes a boss 80 that is secured in a corresponding recess 82 on a bottom surface 84 of the clamp support 64 of the clamping mechanism 62 by welding or other suitable attachment method. Alternatively, the support posts 72 can be integrally formed with the clamp support 64. To adjust the height of the clamping mechanism, a faceted nut 86 is threaded onto each of the support posts 72 on opposing sides of the bracket 78 to secure the support posts at a desired height above the bracket. It should be appreciated that the amount of thread on the support posts 72 is sufficient to allow the appropriate amount of vertical adjustment relative to the work piece. A C-clip 87 or other removable fastener is secured to the bottom ends 76 of the posts 72 below the bracket 78 after the bottom ends 76 are inserted through the through-holes 79 on the bracket to help prevent the support posts from moving out of the bracket when the posts are fully extended.

To adjust the vertical height of the clamping mechanism 62, one of the nuts 86 on each of the posts 72 are rotated in a clockwise direction to move the posts through the nuts and downwardly through the through-holes 79. The respective nuts 86 are rotated until the clamping mechanism 62 reaches a desired height or position relative to the fence member 60. Alternatively, to raise the clamping mechanism 62, the nuts 86 on each post 72 are rotated in a counterclockwise direction, which causes the posts 72 to move upwardly through the nuts 86 and the through-holes 79 on the bracket 78 until the desired height or position relative to the fence member 60 is reached. It should be appreciated that the support posts 72 may be adjusted to be any suitable height or distance above the fence member 60. It is also contemplated that the clamping mechanism 62 can be supported by a single post or a support wall that extends at least partially along the length of the pivot member 72. The adjustment of the position of the clamping mechanism 62 upwardly or downwardly relative to the fence member 60, and more specifically, relative to a work piece, allows the clamping mechanism to be adjusted for work pieces having different thicknesses. It should be appreciated that the above embodiment describes one method of raising and lowering the clamping mechanism and that other suitable means or mechanisms of raising and lowering the clamping mechanism may be employed.

The pivot member 66 of the clamping mechanism 62 includes a first end 88 and a second end 90. The first end 88 of the pivot member 66 includes spaced-apart tubular portions 92 that each define a through-hole 94 that corresponds to the through-hole 70 defined by the clamp support 64. The tubular portion 68 of the clamp support 64 fits within or between the spaced-apart tubular portions 92 of the pivot member 66 so that the through-hole 70 of the clamp support 64 is aligned with the through-holes 94 defined by the tubular portions of the pivot member 66.

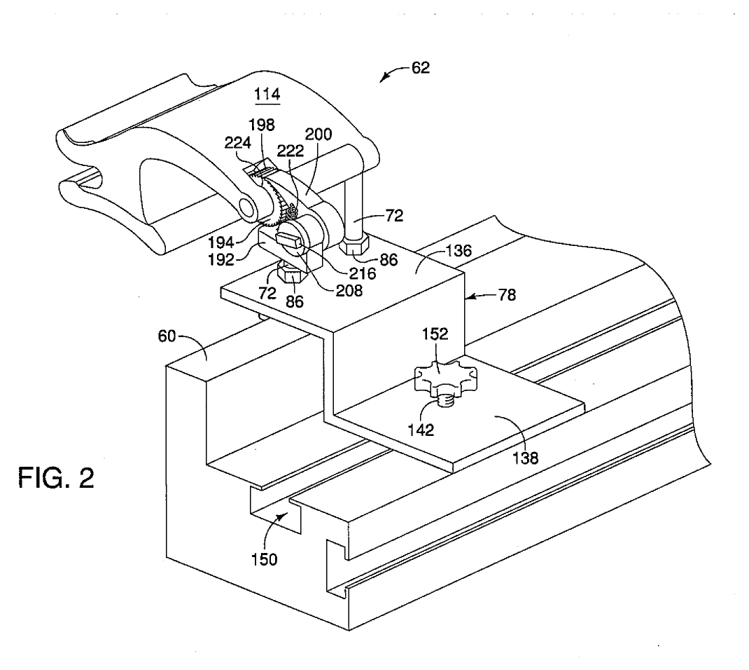

Referring to FIGS. 2-4 and 6, a ratchet assembly 190 including a ratchet mount 192 is mounted to one of the posts 72 by welding or any other suitable connection method. The ratchet assembly 190 includes a gear 194 having an outer peripheral surface 196 with a plurality of teeth 198 that is attached to the pivot member 66 between the tubular portion 92 and the tubular portion 68 of the clamp support 64. In an embodiment, the gear 194 is a separate part that is secured to the pivot member 66. In another embodiment, the gear 194 is integrally molded with the pivot member. In the illustrated embodiment, the ratchet assembly 190 includes a ratchet arm 200 that is rotatably mounted to axle 202. Axle 202 includes a first end or free end 204 and an opposing second end 206 that has a cylindrical cap 208. The ratchet arm 200 is rotatably attached to the ratchet mount 192 by inserting the first end 204 of the axle 202 through a through-hole 210 defined by the ratchet mount 192 and a corresponding through-hole 212 defined by the ratchet arm 200 until the second end 206, and more specifically, the cap 208 engages the ratchet mount. A nut 214 or other fastener is secured to the first end of the axle to prevent the ratchet arm from sliding off of the axle.

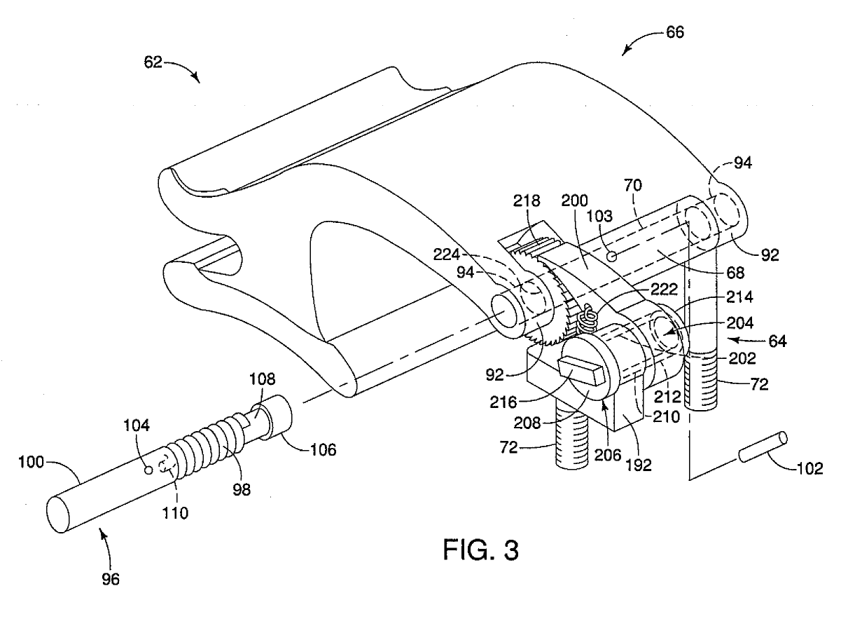

As shown in FIG. 3, the cap 208 includes a protruding grip 216 that allows a user to rotate the axle 202 and thereby the ratchet arm 200 upwardly or downwardly relative to the ratchet mount 192. The ratchet arm includes a lip 218 at one end that is configured to matingly engage each of the recesses 220 formed between the teeth 198 on the gear 194. A bias member, such as coil spring 222, has an end that is attached to the ratchet arm 200 and an opposing end that is attached to the ratchet mount 192. The coil spring 22 biases the ratchet arm 200 downwardly to maintain engagement between the lip 218 and the recesses 220 on the gear 194. As the gear 194 rotates with the pivot member 66, the lip 218 engages one of the recesses 220 to lock the pivot member 66 at a particular position relative to a work piece. To release the lip 218 on the ratchet arm 200 from the gear 194, a user holds and rotates the grip 216 which causes the ratchet arm 200 to move upwardly away from the gear 194. The pivot member 66 is biased upwardly due to the spring 98 until it reaches a desired position relative to the work piece. The user then releases the grip 216 to allow the arm 200 to pivot downwardly until the lip 218 re-engages one of the recesses 220 on the gear 194.

An elongated rod 96 including a spring 98 is inserted through the aligned through-holes 70, 94 of the pivot member 66, through-hole 224 defined by the gear 194 and the clamp support 64 as shown in FIGS. 2 and 3 to allow the pivot member 66 to pivot relative to the clamp support 64. Specifically, a first end 100 of the rod 96 is seated within one of the tubular portions 92 of the pivot member 66 and is secured to the clamp support 64 by inserting a removable pin 102 through holes 103 defined by the tubular portion 68 and 104 defined by the rod. An opposing, second end 106 of the rod 96 is seated within the other tubular portion 92 of the pivot member 66 and freely pivots or rotates within the through-hole 94 defined by the tubular portion as described below. The spring 98 surrounds a middle, narrowed portion 108 of the rod 96 so that the outer surface of the spring is substantially flush with the outer surface of the first and second 100, 106 ends of the rod.

The spring 98 includes a first end 110 and a second end 112 where the first end is secured to the first end of the rod (FIG. 3) and the second end 112 is secured in an opening or slot defined by the pivot member 66 as shown in FIGS. 2 and 3. Thus, the first end 110 of the spring 98 remains stationary while the second end 112 rotates or twists with the movement of the pivot member 66. Pressing down on the pivot member 66 causes the pivot member to move downwardly toward a work piece thereby causing the second end 112 of the spring 98 to pivot or rotate downwardly. The rotation or twisting of the second end 112 of the spring 98 creates torsional tension in the spring, which causes the spring to bias the pivot member 66 away from the work piece.

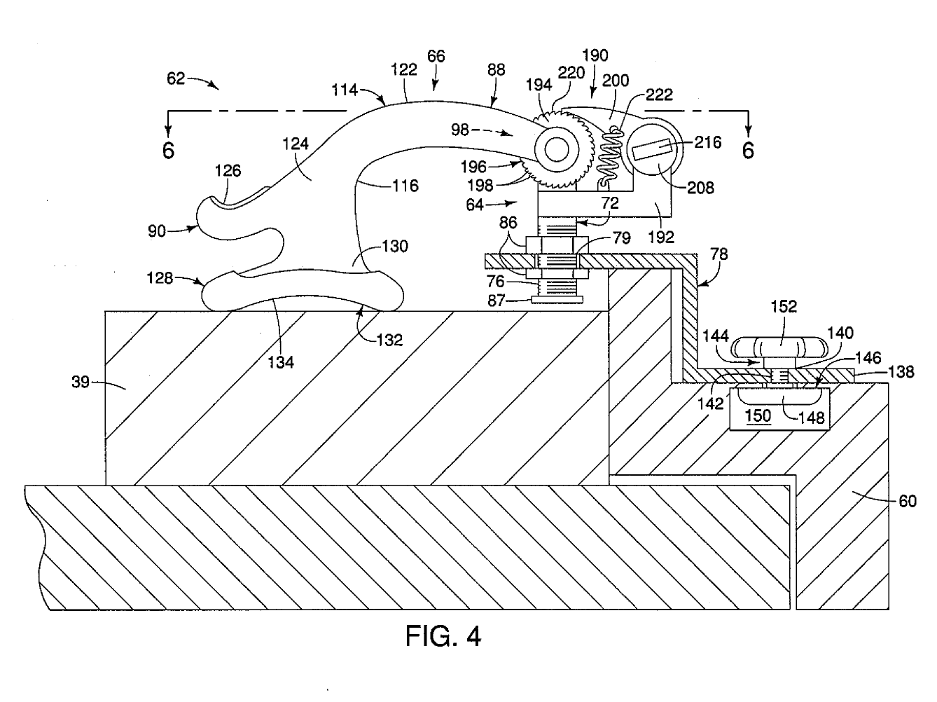

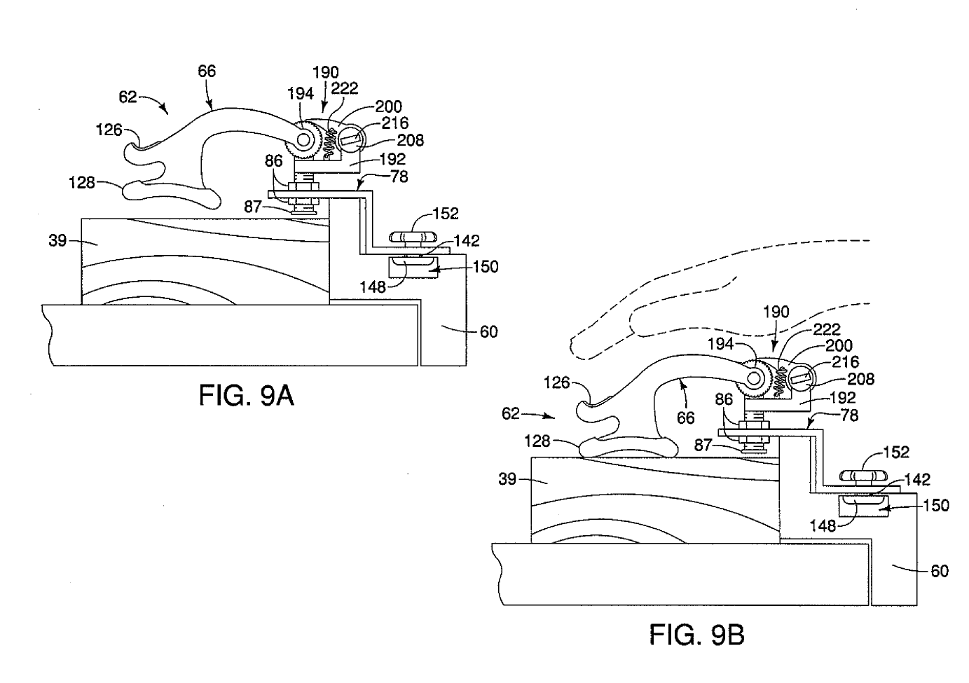

In operation, the pivot member 66 is movable between a release position, where the pivot member is disengaged from the work piece 39 (FIG. 9A), and a securing position, where the pivot member is engaged with the work piece (FIG. 9B). The pivot member 66 includes an upper surface 114 and a bottom surface 116. As described above, the spring 98 shown in FIGS. 3 and 4, biases the pivot member 66 upwardly and away from the work piece 39. It is contemplated that the spring 98 is a torsion spring or a coil spring but may be any suitable spring or combination of springs for biasing the pivot member 66.

When the pivot member 98 is pushed downwardly from a release position (shown in FIG. 9A) towards the work piece 39 to be in the securing position (FIG. 9B), the spring 98 twists or stretches out and biases the pivot member 66 toward the release position. The ratchet assembly 190 secures the pivot member 66 in position relative to the work piece. Specifically, the lip 218 on the ratchet arm 200 engages successive recesses 220 between the teeth 198 on the gear 194 as the gear rotates with the pivot member 66. It should be appreciated that the gear 194 can have smaller or greater number of teeth and the lip 218 on the ratchet arm 200 can be smaller or larger to change the adjustability of the ratchet assembly 190. For example, finer adjustments can be made by increasing the number of teeth on the gear 194 thereby increasing the number of incremental rotational positions of the gear.

Each tooth 198 preceding the recesses 220 has a flat rear surface that prevents the lip 218 from moving out of the respective recess and locks the ratchet arm 200 in position on the gear 194, which in turn, locks the pivot member 66 at a particular position. To release the pivot member 66, a user presses downwardly on the pivot member causing the lip 218 to dis-engage from the respective recess 220 on the gear 194. The user then grabs the grip 216 to rotate the ratchet arm 200 upwardly away from the gear 194. Upon the release of the ratchet arm 200 from the gear 194, the spring 98 contracts or returns to its unstretched position, and biases the pivot member 66 toward the release position.

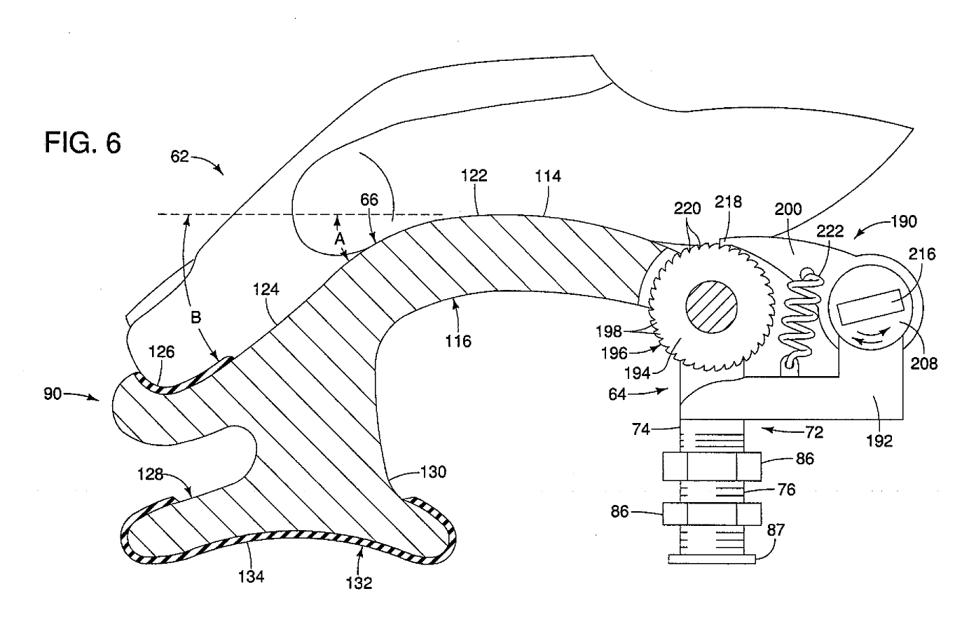

The upper surface 114 of the pivot member 66 is contoured and slopes generally downwardly from the first end 88 towards an opposing second end 90 of the pivot member. Preferably, the upper surface 114 is shaped to correspond to the shape of a human hand as shown in the FIGS. 6 and 9B and includes a palm contacting portion 122 and a finger contacting portion 124, where the palm contacting portion is at an angle “A” between 0° and 15° relative to a horizontal plane extending from the top of the clamp support 64 (see FIG. 6) and the finger contacting portion 124 is at an angle “B” between 15° to 45° relative to that plane. It should be appreciated that the palm contacting portion 122 and the finger contacting portion 124 may be at any suitable angle or angles. The pivot member 66 also includes a finger pad 126 that extends at least partially over the upper surface 114 to provide a pushing surface for a user's fingers as well as to allow a user to better grip the pivot member where the finger pad helps to inhibit movement of the user's fingers beyond an outer edge of the upper surface. This provides a stable smooth surface for a user to control the pivot member 66 during a cutting operation. In an embodiment, the upper surface 114 of the pivot member 66 is made of a non-slip material, such as rubber, that helps to prevent a user's hand from slipping off of the upper surface during use.

The clamping mechanism 62 also includes a foot or shoe 128 that extends downwardly from the bottom surface 116 of the pivot member 66. Specifically, an upper end 130 of the shoe 128 is connected to the pivot member 66. It is contemplated that the shoe 128 may be integrally formed with the pivot member 66 or separately attached to the pivot member by stretching the shoe over a portion of the pivot member or by using suitable fasteners. A lower end 132 of the shoe 128 includes an outer layer or gripping surface 134 that is configured to contact a work piece. The gripping surface 134 may be made of rubber, a rubber-like material or any other suitable non-slip material or materials. In another embodiment, the gripping surface 134 includes non-slip feature or non-slip member 135 such as one or more ribs, protrusions, knurling, abrasions and the like. The non-slip member 135 may be made of a non-slip material such as rubber, a metal such as steel or aluminum or any suitable material or combination of materials. In the illustrated embodiment, the gripping surface 134 of the shoe 128 grips and holds a work piece in position without damaging it so that the work piece does not slip out from under the clamping mechanism 62 during operation.

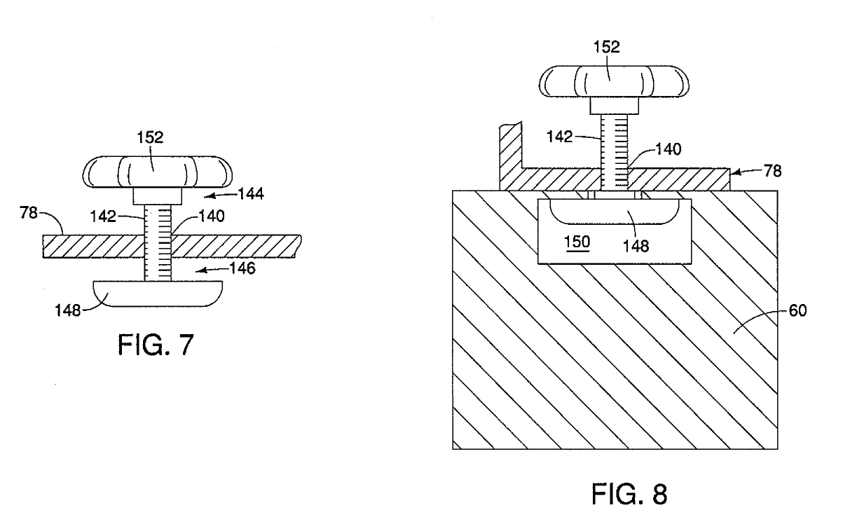

To adjust the lateral position of the clamping mechanism 62 relative to the universal fence 44, the stepped bracket 78 is moved along the fence member 60. The stepped bracket 78 has an upper end 136 and a lower end 138 that is attached to the fence member 60. As shown in FIG. 4, the lower end 138 of the bracket 78 is generally planar and rests on a lower end of the fence member 60. The lower end 138 includes a through-hole 140 that receives a securing member such as threaded bolt 142 having an upper end 144 and a bottom end 146. The bottom end 146 includes a foot 148 (FIGS. 7 and 8) that has a diameter that is greater than the diameter of the through-hole 140. It should be appreciated that the foot 148 may be made of metal, a combination of metals or any suitable material or materials. It should also be appreciated that in another embodiment, the bottom end 146 does not include the foot 148. The foot 148 fits closely to the top surface of the channel 150 such that when the handle 152 is rotated to clamp the bracket 78 in place, the foot 148 is in contact with fence member 60 and thereby keeps the foot from rotating relative to the fence member. This allows the bracket 78 to be clamped to the fence member 60.

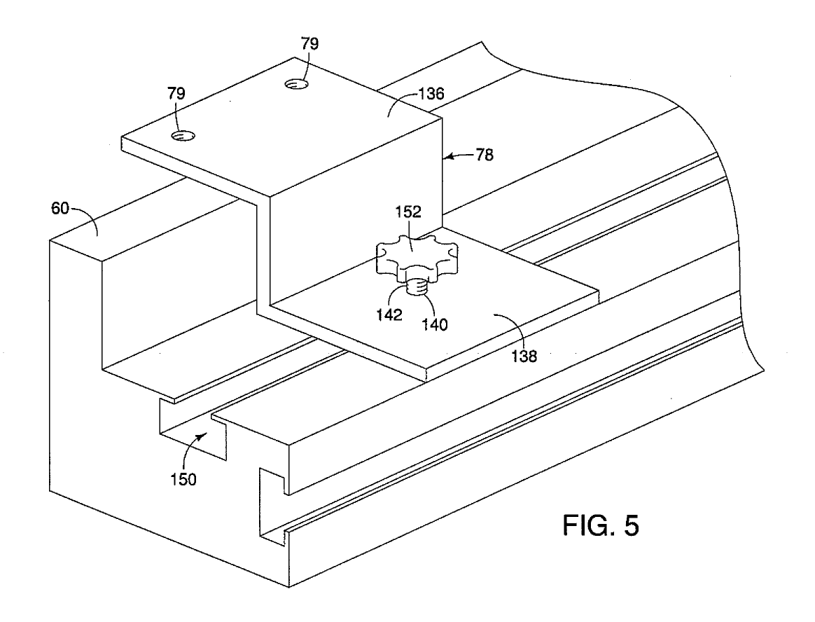

As shown in FIGS. 5, 9A & 9B, the fence member 60 defines an elongated channel 150 where the foot 148 is slidably secured in the channel. A knob 152 is connected to the upper end 144 of the bolt 142 and is rotated to adjust the height and tightness of the foot 148 relative to an inside surface of the channel 150. Preferably the knob 152 is rotated so that the foot 148 and bolt 142 slide within the channel 150 defined by the universal fence 44. This construction allows the clamping mechanism 62 to be movable or slidable laterally along the universal fence 44 to adjust the position of the clamping mechanism relative to the fence member 60. This construction also allows a user to clamp and securely hold the work piece 39 close to the blade to prevent the work piece from moving due to the torque or moment that is generated when the work piece contacts the blade.

In another embodiment, the foot 148 is a square bolt head connected to the bolt 142 where the knob 152 defines a threaded through-hole, i.e., threaded all the way through the knob. The bolt 142 in this embodiment only has to be long enough to allow for clamping and unclamping of the bracket 78 to the fence member 60. It is also contemplated that a stop such as a C-clip or other suitable clip or stop member can be secured above the knob 152 on the bolt 142 to prevent the knob from falling off of the bolt during use.

The upper end 136 of the bracket 78 extends laterally out beyond the edge of the fence member 60 and defines the through-holes 79 that are configured to receive the support posts 72. As shown in FIG. 4, each of the through-holes 79 has a diameter that is greater than a diameter of the bottom ends 76 of the posts so that the posts can freely move through the through-holes. The posts 72 are secured to the bracket 78 by nuts 86 and C-clip 87. As shown in FIG. 4, the nuts 86 are secured to each of the posts on the opposite side of bracket 78 thereby positioning a nut above and below the bracket 78 on the posts to allow the posts to be fully clamped and adjustable vertically relative to the bracket. In the illustrated embodiment, one of the nuts 86 on each of the posts 72 are rotated in clockwise or counterclockwise direction to respectively raise or lower the posts 72 relative to the bracket 78 to adjust the height of the clamping mechanism 62 relative to a work piece 39.

In operation, a user adjusts the height of the clamping mechanism 62 relative to the work piece 39 by rotating or turning nuts 86 using their fingers or a wrench so that the clamping mechanism can securely hold the work piece 39 in position on the table top 12. In particular, the pivot member 66 initially starts in the release position or the position in which the pivot member is disengaged from the work piece 39. The user then places one of their hands on the upper surface 114 of the pivot member 66 and pushes downwardly on the pivot member until the shoe 128 engages the work piece 39, i.e., the securing position. The shoe 128, and more specifically, the gripping surface 134 of the shoe, grips the top surface of the work piece 39 under the pressure of the user's hand and remains clamped when the user removes their hand due to the engagement of the lip 218 of the ratchet arm 200 in one of the recesses 220 on the gear 194. To release the pivot member 66, the user pushes downwardly on the pivot member while rotating the ratchet arm 200 upwardly away from the gear 194 as described above. The user then releases pressure on the upper surface 114 of the pivot member 66, which causes the spring 98, to bias the pivot member upwardly away from the work piece 39 toward the release position. Another work piece can now be inserted under the clamping mechanism 62 and the operation repeated. Thus, the present clamping mechanism 62 quickly and safely holds a work piece in place during a cutting operation without exposing a user's hands or fingers to injury by the blade 32.

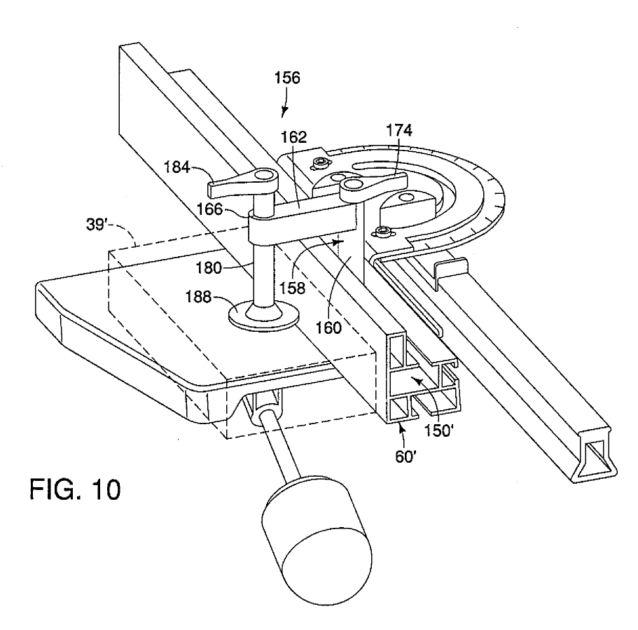

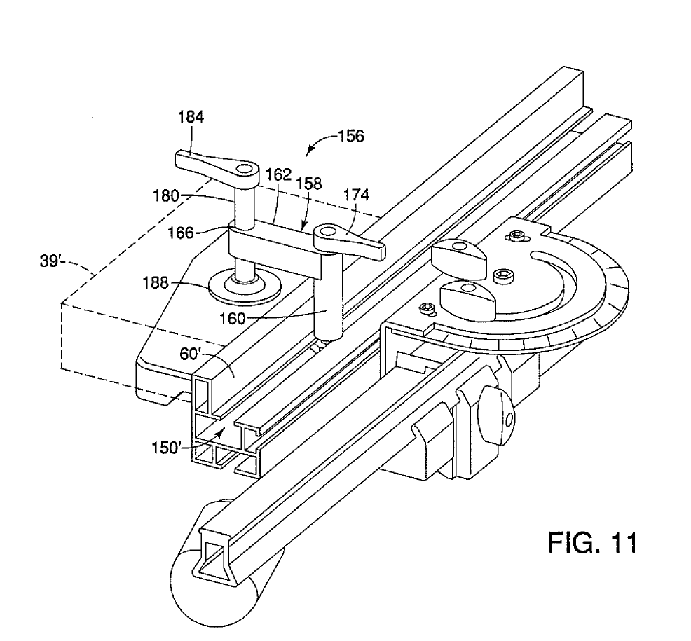

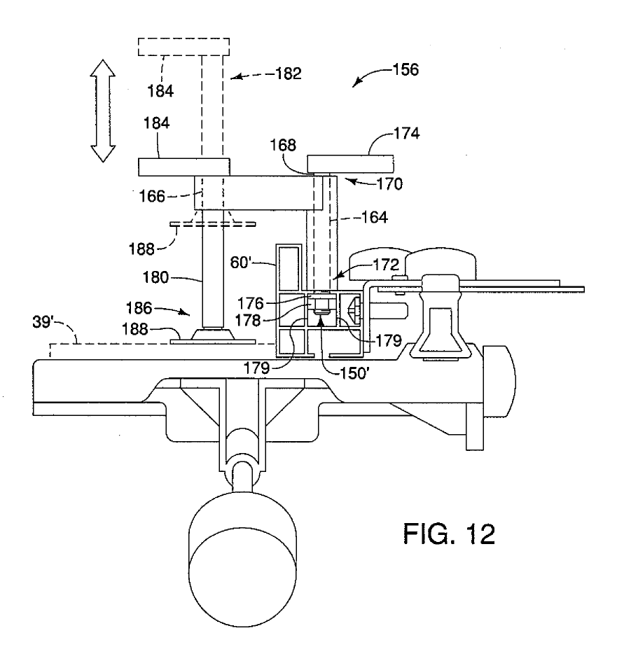

In a further embodiment, and referring to FIGS. 10-13, a clamping mechanism 156 includes a generally L-shaped support 158 having a first generally vertical portion 160 and a second generally horizontal portion 162 integrally formed with the vertical portion. The first portion 160 defines a through-hole 164 including a threaded interior surface. The second portion 162 also defines a through-hole 166 that is spaced a designated distance from through-hole 164. A securing member such as first threaded rod 168 extends through and is threadingly engaged with the through-hole 164 defined by the first portion 160. The first rod 168 has a first end 170 and an opposing second end 172. The first end 170 extends above the upper end of the first portion 160 and includes a first handle 174 that enables a user to grip and rotate the first rod 168. The second end 172 extends below the first portion 160 and into the channel 150′ by the fence member 60′ as shown in FIGS. 11 and 12. A clamping ring 176 and a locking nut 178 are connected to the second end 172 within the channel 150′. The locking nut 178 is restrained from rotating by contact with walls 179 defining the channel 150′ of the fence member 60. It should be appreciated that the locking nut 178 may also be restrained from rotating by other suitable restraining or locking devices or methods.

In the illustrated embodiment, the channel 150′ defines a slot having a width that is greater than a diameter of the first rod 168 to allow the second end 172 to extend through the slot and into the channel. The diameter of the clamping ring 176 is greater than the width of the slot in the channel 150′ so that when the first handle 174 is rotated in a clockwise direction, the first rod 168 moves downwardly in the slot in the first portion until the clamping ring 176 engages the fence member, i.e., the locked position. The locking nut 178 secures the clamping ring 176 in place so that the clamping ring securely engages the fence member 60′ to lock the clamping mechanism 156 in position. To loosen the clamping ring 176, the first handle 174 is rotated in a counterclockwise direction, which causes the first rod 168 to move upwardly within the slot thereby disengaging the clamping ring 176 from the fence member 60′, i.e., the release position. This allows the second end 172 of the first rod 168 to slide in the channel 150′ relative to the fence member.

A second rod 180 extends through and threadingly engages the through-hole 166 defined by the second portion 162 of the L-shaped support 158. A first end 182 of the second rod 180 includes a second handle 184 configured to allow a user to rotate the second rod in a clockwise or counterclockwise direction. A second opposing end 186 of the second rod 180 extends below the through-hole 166 and includes a clamp or foot 188 having a diameter that is greater than a diameter of the second rod 180. The foot 188 has a generally circular shape but may be any suitable size or shape. Preferably, the foot 188 is made of rubber. It should be appreciated that the foot may be made of any suitable non-slip material or materials. When the clamping mechanism 156 is secured in place relative to the fence member 60′ as described above, the second handle 184 on the second rod 186 is rotated in a clockwise direction to cause the second rod to move downwardly through the through-hole 166 until the foot 188 contacts and securely engages a work piece 39′, i.e., the securing position. The rubber foot 188 helps to prevent the work piece 39′ from sliding relative to the foot and also helps to protect the work piece from being damaged by the end of the second rod 180 as it presses on the work piece. The second rod 180 is rotated in a counterclockwise direction to cause the foot 188 to disengage from the work piece 39′ as the rod moves upwardly through the through-hole 166, i.e., move from the securing position to the release position. The second rod 180 has a designated length to adjust to work pieces having different thicknesses. It should be appreciated that the first and second handles 174, 184 can be knobs or any other suitable gripping member. It should also be appreciated that the clamping mechanism 156 rotates about the first rod 168 so that the clamping mechanism can be moved or rotated to different positions relative to a work piece to allow flexibility in securing the work piece. Thus, the clamping mechanism 156 can move linearly in the channel 150′ and also rotationally about the axis defined by the first rod 168.

In operation, a work piece 39′ is placed on the table top 12 of the power saw 10 and the clamping mechanism 156 is moved laterally along the fence member 60′ and also rotationally about the first rod 168 to a desired position relative to the work piece. The user then rotates the first handle 174 on the clamping mechanism 156 while holding the clamping mechanism 156 from moving rotationally to cause the clamping ring 176 to engage an inside surface of the channel 150′. The locking nut 178 engages the clamping ring 176 to securely hold the clamping ring in position. After the clamping mechanism 156 is locked into position on the table saw 10, the user rotates the second handle 184 in a clockwise direction until the foot 188 securely engages the work piece 39′. The user can now safely utilize the saw without having to hold the work piece in place with their hand, which is a safety concern.

After the work piece 39′ has been cut, the user rotates the second handle 184 in a counterclockwise direction, which disengages the foot 188 from the work piece. The work piece 39′ can now be removed from the table saw. The user can also loosen the clamping ring 176 from the channel 150′ by rotating the first handle 174 in a counterclockwise direction. This enables the user to move the clamping mechanism 156 laterally along the fence member 60′ and/or rotationally about the axis defined by the first rod 168 as needed.

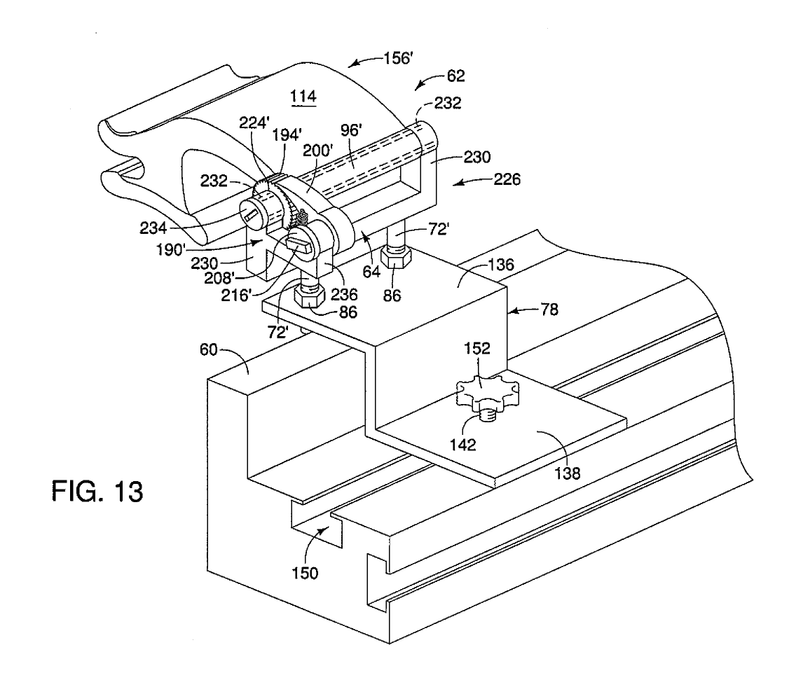

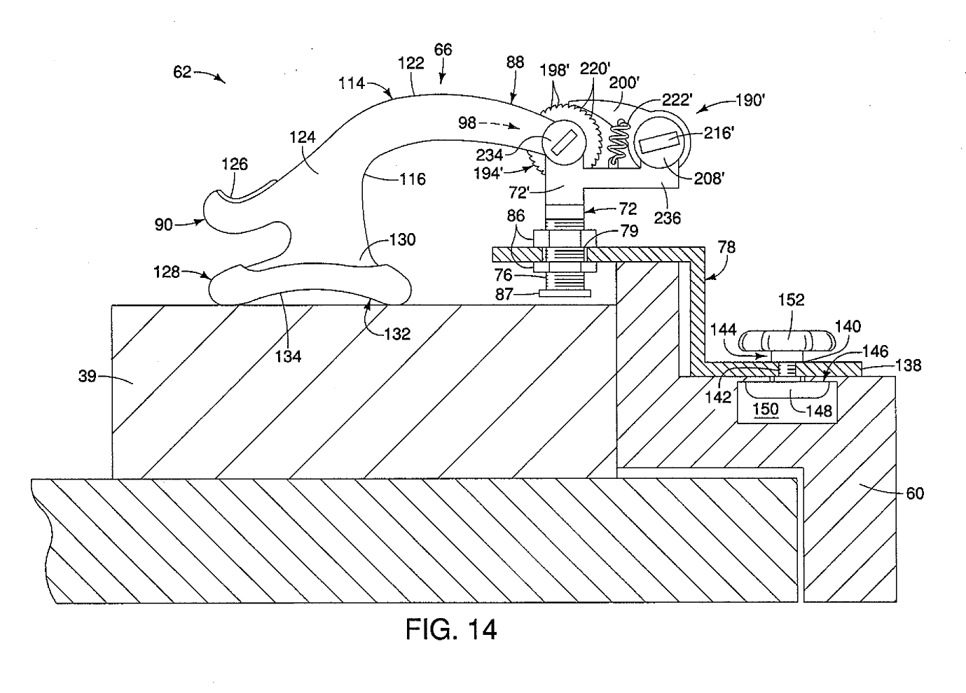

Referring now to FIGS. 13-15B, another embodiment of the ratchet assembly 190′ is illustrated where the clamping mechanism 156′ includes a mounting assembly 226 attached to the posts 72′ by screws or other suitable fasteners. It should be appreciated that the mounting assembly 226 may also be integrally formed with the posts 72′. In the illustrated embodiment, the mounting assembly 226 includes two spaced apart vertical supports 230 that each define generally horizontal through-holes 232 for receiving the rod 96′ as described above. In this embodiment, the rod 96′ includes an enlarged end or cap 234 that engages an outer surface of one of the vertical supports 230 when the rod is fully inserted through the through-holes 232 defined by the vertical supports 230 and the pivot member 66′. Alternatively, the cap 234 may be a separate part that is attached to the rod 96′ using a suitable attachment method.

The ratchet assembly 190′ is mounted on an extended portion 236 of the mounting assembly 226 as shown in FIG. 13. A gear 194′ is attached to pivot member 66′ and is configured to fit between the vertical supports 230. The gear 194′ defines a through-hole 224′ configured to receive the rod 96′. Thus, the rod 96′ is inserted through the one of the vertical supports 230, the gear 194′, the pivot member 66′ and the opposing vertical support 230. The rod 96′ is secured in position as described above so that the rod does not slide out of the vertical supports 230 during operation. The gear 194′ is attached to the pivot member 66′ using any suitable fastener or fastening method so that the gear rotates or pivots in unison with the pivot member. Similar to the ratchet assembly described above, the illustrated ratchet assembly 190′ includes a ratchet arm 200′ having a lip 218′ at one end that engages one of the recesses 220′ defined between the teeth 198′ on the gear 194′. The ratchet arm 200′ is rotatably mounted to a ratchet mount 192′ integrally formed with the extending portion 236 of the mounting assembly 226 by inserting an axle 202′ through through-holes 210′ and 212′ defined by the ratchet mount and the ratchet arm as shown in FIG. 13. A cap 208′ having a grip 216′ is secured to one end of the axle 202′ rotates with the axle relative to the ratchet mount 192′. The grip 216′ is a rectangularly-shaped protrusion that can be grasped by a user to pivot the ratchet arm 200′ upwardly away from the gear 194′ as described above. A spring 222′ is connected between the ratchet arm 200′ and the extending portion 236 of the mounting assembly 226 to bias the ratchet arm downwardly into engagement with the gear.

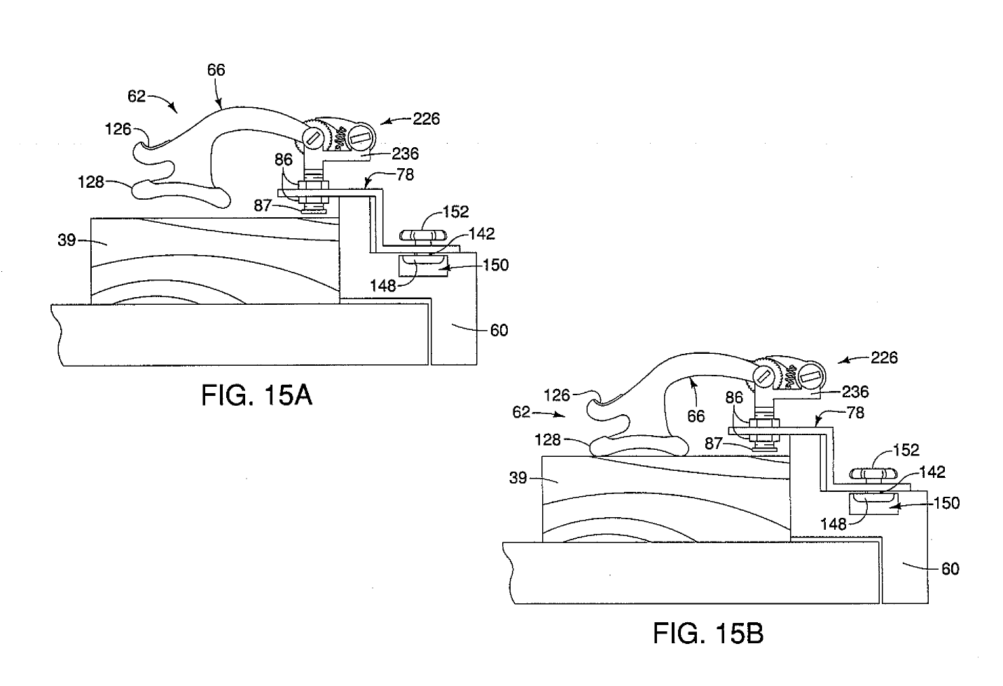

In operation, the pivot member starts in the release position shown in FIG. 15A where the lip 218′ at the end of the ratchet arm 200′ engages each successive recess 220′ between the teeth 198′ on the gear 194′ as the pivot member 66′ and the gear 194′ rotate downwardly toward a work piece. The ratchet arm 200′ locks the pivot member 66′ in a particular position relative to the work piece as shown in FIG. 15B. To release the pivot member 66′ so that it can pivot or rotate upwardly away from the work piece, a user pushes down on the pivot member to cause the ratchet arm 200′ to dis-engage from the respective recess 220′ on the gear 194′. At the same time, the user grasps the grip 216′ and rotates or pivots the ratchet arm 200′ upwardly away from the gear 194′ which allows the pivot member to pivot or rotate upwardly due to the coil spring 98′ to the release position shown in FIG. 15A. The work piece can now be removed and a new work piece can be inserted under the clamping mechanism where the process is repeated to secure the new work piece in position.

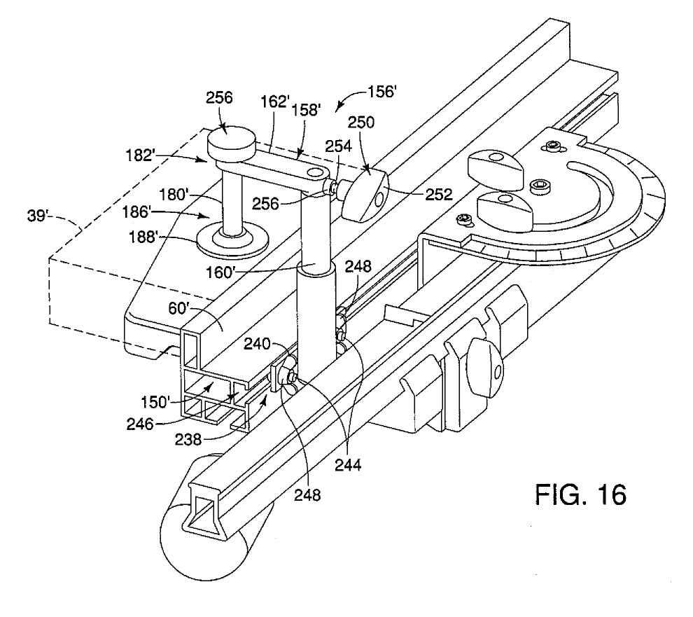

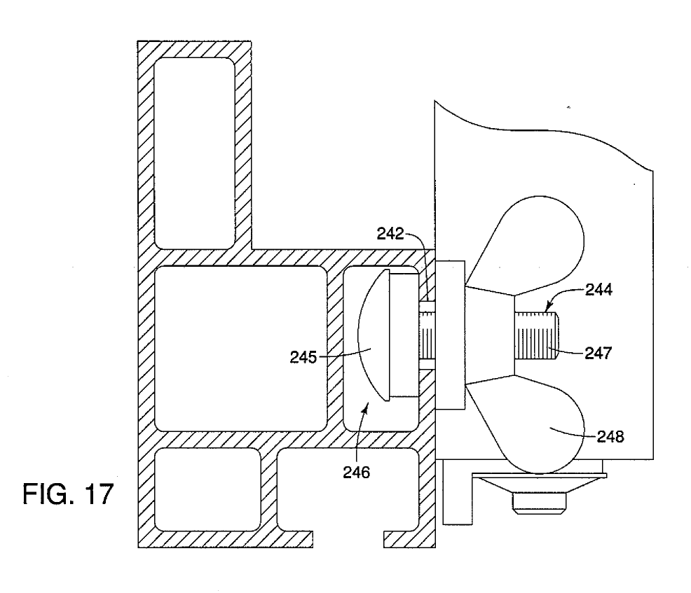

Referring now to FIGS. 16 and 17, another embodiment of the clamping mechanism 156′ includes a generally L-shaped support 158′ having a first generally vertical portion 160′ and a second generally horizontal portion 162′ integrally formed with the vertical portion. The vertical portion 160′ is secured to the fence member 60′ by a connecting portion 238 including a connecting bracket 240 defining a pair of holes 242 on opposing sides of the vertical portion 160′ configured to receive fasteners 244. It should be appreciated that the fasteners 244 may be bolts, screws or any suitable fasteners. Each of the fasteners 244 include head portions 245 and are positioned in channel 246 such that the head portions engage an inner surface of the channel and threaded ends 247 of the fasteners extend through the holes 242. A wing nut 248 is threadingly secured to the ends 247 of each of the fasteners 244 to secure the bracket 240 and the clamping mechanism 156′ in position relative to the fence member 60′.

To move the clamping mechanism 156′ relative to the fence member 60′, a user loosens the wing nuts 248 by rotating them in a counterclockwise direction. The clamping mechanism 156′ then slides relative to the fence member 60′ in either direction. The fastener heads 245 have a diameter that is greater than a diameter of the holes 242 so that the fasteners 244 remain in engagement with the fence member 60′ while the clamping mechanism 156′ is being moved relative to the fence member. Once the clamping mechanism 156′ is at a desired position on the fence member 60′, the wing nuts 248 are rotated in a clockwise direction to tighten and secure the bracket 240 against the fence member.

In the illustrated embodiment, the clamping mechanism 156′ includes a position control 250 that adjusts the vertical position of the clamping mechanism relative to a work piece. The position control 250 includes a handle or knob 252 and a threaded end 254 connected to the knob. The horizontal support 162′ includes a boss 256 defining a threaded hole configured to receive the threaded end 254 of the position control. The knob 252 is rotated in a clockwise direction to tighten and secure the clamping mechanism 156′ at a particular vertical position. To adjust the vertical position of the clamping mechanism 156′, a user rotates the knob 252 in a counterclockwise direction, moves the clamping mechanism upwardly or downwardly relative to a work piece 39′, and then rotates the knob in a clockwise direction to secure the clamping mechanism at a desired vertical position relative to the work piece.

A second rod 180′ extends through and threadingly engages the L-shaped support 158′. A first end 182′ of the second rod 180′ includes a handle or round knob 256 configured to allow a user to rotate the second rod in a clockwise or counterclockwise direction. A second opposing end 186′ of the second rod 180′ includes a clamp or foot 188′ having a diameter that is greater than a diameter of the second rod 180′. The foot 188′ has a generally circular shape but may be any suitable size or shape. Preferably, the foot 188′ is made of rubber. It should be appreciated that the foot may be made of any suitable non-slip material or materials. When the clamping mechanism 156′ is secured in place relative to the fence member 60′ as described above, the round knob 256 on the second rod 186′ is rotated in a clockwise direction to cause the second rod to move downwardly until the foot 188′ contacts and securely engages a work piece 39′, i.e., the securing position. The rubber foot 188′ helps to prevent the work piece 39′ from sliding relative to the foot and also helps to protect the work piece from being damaged by the end of the second rod 180′ as it presses on the work piece. The second rod 180′ is rotated in a counterclockwise direction to cause the foot 188′ to disengage from the work piece 39′ as the rod moves upwardly, i.e., moves from the securing position to the release position. As stated above, the clamping mechanism 156′ can move linearly in the channel 246 and also rotationally about the axis defined by the vertical support 160′.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A clamping mechanism for securing a work piece on a power tool having a working surface and a guide fence, the clamping mechanism comprising:
a support configured to be movable along the guide fence; and
a clamp interconnected to said support, said clamp being movable between a securing position and a release position, wherein in said securing position, said clamp engages a work piece, and in said release position, said clamp is disengaged from the work piece.

2. The clamping mechanism as defined in claim 1, further comprising a pivot member connected to said clamp and configured to adjust a position of said clamp relative to the work piece.

3. The clamping mechanism as defined in claim 1, wherein a shoe is attached to a bottom end of said clamp and configured to engage and hold the work piece.

4. The clamping mechanism as defined in claim 3, wherein said shoe has at least an outer layer configured to contact the work piece that includes at least one of a non-slip material and a non-slip member.

5. The clamping mechanism as defined in claim 3, wherein said non-slip material is rubber or a rubber-like material.

6. The clamping mechanism as defined in claim 1, further comprising a pivot member connected to said clamp and said support, wherein said pivot member is configured to allow said clamp to pivot between said securing position and said release position.

7. The clamping mechanism as defined in claim 1, wherein said support includes an securing member movable between a locked position and a release position, wherein in said locked position, said support is secured to the guide fence, and in said release position, said support is disengaged from the guide fence to enable said support to move relative to the guide fence.

8. A clamping mechanism for securing a work piece on a table top of a power saw, the power saw including a guide fence for aligning the work piece relative to a blade extending through the table top, the clamping mechanism comprising:
a support connected to the guide fence, said support being movable along a length of the guide fence;
a clamp pivotably connected to the support, said clamp pivoting between a release position, wherein said clamp is disengaged from the work piece, and a securing position, wherein said clamp is engaged with the work piece;
a biasing member connected to said clamp and configured to bias said clamp to said release position; and
a ratchet assembly releasably engagable with said clamp for securing the clamp at a designated position relative to the work piece.

9. The clamping mechanism of claim 8, wherein said support includes a securing member configured to be movable between a release position, wherein said support is disengaged from the guide fence, and a locked position, wherein said support is secured to the guide fence.

10. The clamping mechanism of claim 8, wherein a finger pad is attached to an upper surface of said clamp for inhibiting movement of the user's fingers beyond an outer edge of said upper surface.

11. The clamping mechanism of claim 8, further comprising two spaced apart support posts each having a top end and a bottom end, wherein said top ends of said support posts are connected to said clamp and said bottom ends of said support posts are connected to said support, said support posts being configured to adjust a vertical position of said clamp relative to the work piece.

12. The clamping mechanism of claim 8, wherein said support includes a securing member, a first end and an opposing second end, said first end being connected to said clamp and said second end being movably connected to the guide fence, said securing member being configured to adjust a vertical position of said clamp relative to the guide fence.

13. The clamping mechanism of claim 8, wherein a bottom surface of said clamp includes a shoe configured to engage the work piece when said clamp is pivoted to said securing position.

14. The clamping mechanism of claim 13, wherein said shoe has at least an outer layer configured to contact the work piece that includes at least one of a non-slip material and a non-slip member.
